(19) United States
(12) Patent Application Publication
(10) Pub. No.: US 2020/0028456 A1
(43) Pub. Date: Jan. 23, 2020

(54) MOTOR DRIVE CONTROL DEVICE, MOTOR, AND BLOWER APPARATUS

(71) Applicant: Nidec Corporation, Kyoto (JP)

(72) Inventors: Hiroki MORIOKA, Kyoto (JP); Yasoya HARA, Kyoto (JP)

(21) Appl. No.: 16/438,753

(22) Filed: Jun. 12, 2019

(30) Foreign Application Priority Data
Jul. 20, 2018 (JP) 2018-136999

(51) Int. Cl. H02P 6/20; H02P 6/15; H02P 6/182; F04D 25/06

(52) U.S. Cl. CPC H02P 6/20; H02P 6/157; H02P 2203/03; F04D 25/06; H02P 6/182

(57) ABSTRACT

A motor drive control device that controls driving of a motor unit to which a three-phase AC voltage is inputted switches an energization pattern to a phase winding of the motor unit in a predetermined order, and detects a current value flowing through the motor unit for each energization pattern and stores the current value. In start-up operation of the motor unit, the motor drive control device starts synchronized operation when a second current value detected at the energization in the energization pattern of a second or subsequent time is smaller than a first current value detected at the energization in the energization pattern of a first time for m (m is a positive integer of two or more) consecutive times. In the synchronized operation, the energization pattern is switched according to rotational position information of a rotor generated based on a detection result of a voltage of the phase winding.

### CROSS REFERENCE TO RELATED APPLICATION

The present invention claims priority under 35 U.S.C. § 119 to Japanese Application No. 2018-136999 filed on Jul. 20, 2018 the entire content of which is incorporated herein by reference.

### 1. FIELD OF THE INVENTION

The present disclosure relates to a motor drive control device, a motor, and a blower apparatus.

### 2. BACKGROUND

A blower apparatus equipped with a sensorless control type brushless direct current (DC) motor has been conventionally known. In the sensorless control type brushless DC motor, a rotational position of a rotor is detected based on an induced voltage occurring in the rotor. However, at the time of start-up, the rotor is stopped or rotated at a low speed, so that the rotational position of the rotor is not detected. For example, in JP 2010-045941 A, after the rotor is raised to a predetermined rotation speed by forced commutation, the forced commutation is stopped and the rotational position of the rotor is detected in a state of inertial rotation, and then, the rotor shifts to sensorless control.

The start-up by the forced commutation causes the rotor to rotate by a rotating magnetic field from a stator irrespective of the rotational position of the rotor. Thus, the rotor is sometimes difficult to rotate smoothly. Also, since a level of the induced voltage generated by the rotor is low at the time of the start-up, it is difficult to detect the rotational position of the rotor. Thus, a shift from the forced commutation at the time of the start-up to the sensorless control sometimes fails. In order to restart the brushless DC motor when the shift to the sensorless control fails, the forced commutation is executed after the rotor is stopped by performing initial processing such as short brake and the like. Thus, it takes time to restart. When only the forced commutation is repeatedly performed while the initial processing is sandwiched, the shift to the sensorless control may fail repeatedly.

It is an object of the present disclosure to provide a motor drive control device, a motor, and a blower apparatus in which a start-up success rate of a motor unit can be increased.

### SUMMARY

An exemplary motor drive control device according to the present disclosure includes a drive control unit that controls driving of a motor unit to which a three-phase alternating current (AC) voltage is inputted and that switches an energization pattern to phase windings of the motor unit in a predetermined order, a current detection unit that detects a current value flowing through the motor unit, a storage unit that stores the current value detected by the current detection unit for each energization in the energization pattern, a voltage detection unit that detects a voltage of each of the phase windings, and a position information generation unit that generates rotational position information of a rotor of the motor unit in a rotational direction based on a detection result of the voltage detection unit. In start-up operation of the motor unit, the drive control unit starts synchronized operation for switching the energization pattern according to the rotational position information when a second current value detected by the current detection unit at energization of a second or subsequent time in the energization pattern is smaller than a first current value detected by the current detection unit at energization of a first time in the energization pattern for m (m is a positive integer of two or more) consecutive times.

An exemplary motor according to the present disclosure includes the motor unit to which the three-phase AC voltage is inputted, and the motor drive control device that controls the driving of the motor unit.

An exemplary blower apparatus of the present disclosure includes an impeller having blades rotatable around a central axis extending in a vertical direction, and the motor for rotating the blades.

According to the exemplary motor drive control device, the motor, and the blower apparatus of the present disclosure, a start-up success rate of the motor unit can be increased.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a block diagram illustrating an example of a blower apparatus.

FIG. 2 is a flowchart for describing an example of drive control of a motor unit.

FIG. 3 is a graph illustrating an example of a terminal voltage detected in accordance with an electrical angle of a rotor in sensorless control of the motor unit.

FIG. 4 is a flowchart for describing an example of start-up operation of the motor unit.

FIG. 5A is a graph illustrating an example of a current value flowing through the motor unit in each energization period.

FIG. 5B is a graph illustrating an example of the current value flowing through the motor unit in each energization period.

FIG. 6A is a flowchart for describing a first example of processing of energizing in a different energization pattern.

FIG. 6B is a flowchart for describing a second example of the processing of energizing in the different energization pattern.

FIG. 6C is a flowchart for describing a third example of the processing of energizing in the different energization pattern.

### DETAILED DESCRIPTION

An example embodiment of the present disclosure will be described below with reference to the drawings.

In this specification, a direction parallel to a central axis CA of rotation of a motor unit 1 and blades 111 in a blower apparatus 100 is referred to as “axial direction”.

Each of a U-phase winding 12u, a V-phase winding 12v, and a W-phase winding 12w of a stator 11 of the motor unit 1, or a generic term thereof is sometimes referred to as a phase winding 12. In a three-phase AC voltage, a phase energized to the phase winding 12 is referred to as an energized phase, and a phase not energized to the phase winding 12 is referred to as a non-energized phase. A combination of the two phase windings 12 that are energized is referred to as an energization pattern. Each of a U-phase voltage, a V-phase voltage, and a W-phase voltage of the three-phase AC voltage, or a generic term thereof is sometimes referred to as a phase voltage.

### 1. Example Embodiment

### 1-1. Configuration of Blower Apparatus

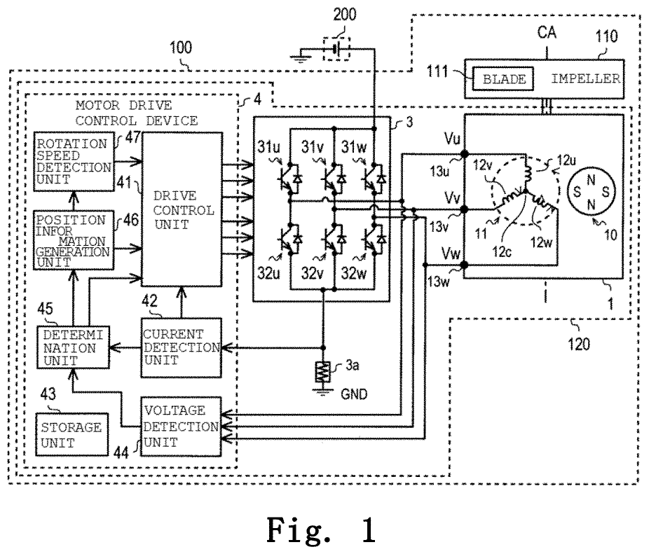

FIG. 1 is a block diagram illustrating an example of a blower apparatus 100. In the present example embodiment, the blower apparatus 100 is an axial flow fan that generates an airflow flowing from one side to the other side in an axial direction. The blower apparatus 100 is not limited to this exemplification, and the blower apparatus 100 may be a centrifugal fan that delivers air drawn in from the axial direction to an outside in a radial direction.

As shown in FIG. 1, the blower apparatus 100 includes an impeller 110 and a motor 120. The impeller 110 has blades 111 rotatable around a central axis CA extending in a vertical direction. The motor 120 drives the impeller 110 to rotate, so that the blades 111 are rotated. A DC power source 200 is connected to the blower apparatus 100. The DC power source 200 is a power source of the blower apparatus 100. As shown in FIG. 1, a positive output terminal on a high voltage side of the DC power source 200 is connected to an inverter 3 of the motor 120 to be described later. A negative output terminal on a low voltage side of the DC power source 200 is grounded.

### 1-2. Constituent Elements of Motor

Each constituent element of the motor 120 will be described below. The motor 120 includes a motor unit 1, the inverter 3, and a motor drive control device 4.

As described above, the motor 120 includes the motor unit 1. A three-phase AC voltage is inputted to the motor unit 1 from the inverter 3. The motor unit 1 is, for example, a three-phase brushless DC motor (BLDC motor). More specifically, the motor unit 1 includes a rotor 10 and a stator 11. The rotor 10 is provided with permanent magnets. The stator 11 is provided with a U-phase winding 12u, a V-phase winding 12v, and a W-phase winding 12w. In the present example embodiment, the phase windings 12u, 12v, 12w are connected in a Y connection around a point 12c. In the phase windings 12u, 12v, 12w, opposite end sides to the point 12c are connected to terminals 13u, 13v, 13w of the motor unit 1 respectively. The phase windings 12u, 12v, 12w are not limited to this exemplification, and they may be connected in a Δ (delta) connection.

As described above, the motor 120 includes the inverter 3. The inverter 3 outputs the three-phase AC voltage to the motor unit 1. The inverter 3 has upper arm switches 31u, 31v, 31w and lower arm switches 32u, 32v, 32w. The upper arm switches 31u, 31v, 31w and the lower arm switches 32u, 32v, 32w form a bridge circuit that produces the three-phase AC voltage to be outputted to the motor unit 1. The bridge circuit includes a U-phase arm in which the upper arm switch 31u on the high voltage side and the lower arm switch 32u on the low voltage side are connected in series, a V-phase arm in which the upper arm switch 31v on the high voltage side and the lower arm switch 32v on the low voltage side are connected in series, and a W-phase arm in which the upper arm switch 31w on the high voltage side and the lower arm switch 32w on the low voltage side are connected in series. The above arms are connected in parallel to each other. A high voltage side end of each arm is connected to the high voltage side terminal of the DC power source 200. DC voltage from the DC power source 200 is applied to each arm. A low voltage side end of each arm is grounded via a current detection resistance 3a.

Each of the upper arm switches 31u, 31v, 31w and the lower arm switches 32u, 32v, 32w includes a switching element and a diode. For each switching element, for example, a field effect transistor (FET) or an insulated gate bipolar transistor (IGBT) is used. Each diode is connected in parallel to the switching element with a direction from the low voltage side to the high voltage side of the DC power source 200 as a forward direction. That is, an anode of each diode is connected to a low voltage side end of the switching element, and a cathode is connected to a high voltage side end of the switching element. Each diode functions as a freewheel diode. Each diode may be a body diode incorporated in the FET, or may be externally attached to the switching element.

As described above, the motor 120 includes the motor drive control device 4. The motor drive control device 4 controls driving of the motor unit 1. More specifically, the motor drive control device 4 executes pulse width modulation (PWM) control of the inverter 3 and controls the driving of the motor unit 1 via the inverter 3. The motor drive control device 4 detects a current flowing from the low voltage side end of the bridge circuit of the inverter 3 to the current detection resistance 3a, and, based on its detection result, detects a current value I flowing from the inverter 3 to the motor unit 1.

### 1-3. Constituent Elements of Motor Drive Control Device

As shown in FIG. 1, the motor drive control device 4 includes a drive control unit 41, a current detection unit 42, a storage unit 43, a voltage detection unit 44, a determination unit 45, a position information generation unit 46, and a rotation speed detection unit 47.

As described above, the motor drive control device 4 includes the drive control unit 41. The drive control unit 41 controls the driving of the motor unit 1 to which the three-phase AC voltage is inputted, and switches an energization pattern to the phase winding 12 of the motor unit 1 in a predetermined order n. It should be noted that n is a positive integer. For example, the drive control unit 41 executes sensorless control of the driving of the motor unit 1 using a program and information stored in the storage unit 43. The drive control unit 41 controls the upper arm switches 31u, 31v, 31w or the lower arm switches 32u, 32v, 32w of the inverter 3 by PWM pulses, respectively, so that the drive control unit 41 controls the driving of the motor unit 1 using the inverter 3 to output the three-phase AC voltage to the motor unit 1.

As described above, the motor drive control device 4 includes the current detection unit 42. The current detection unit 42 detects the current value I flowing through the motor unit 1. In the present example embodiment, the current detection unit 42 detects the current flowing through the current detection resistance 3a connected between the bridge circuit of the inverter 3 and a ground terminal GND, and detects the current value as the current value I flowing through the motor unit 1.

The storage unit 43 is a non-transitory storage medium that maintains storage even when power supply is stopped. The storage unit 43 stores information used in each constituent element of the motor drive control device 4, and particularly stores programs and control information used in the drive control unit 41. As described above, the motor drive control device 4 includes the storage unit 43. The storage unit 43 stores, for example, the current value I detected by the current detection unit 42 for each energization in the energization pattern. The storage unit 43 is not limited to this exemplification, and the current value I for each energization in the energization pattern may be stored in a transitory memory (not shown). The storage unit 43 stores a threshold and the like used in the determination unit 45.

As described above, the motor drive control device 4 includes the voltage detection unit 44. The voltage detection unit 44 detects a voltage of the phase winding 12. In the present example embodiment, for example, the voltage detection unit 44 detects a terminal voltage of the terminal 13 connected to the non-energized phase winding 12 among terminal voltages Vu, Vv, Vw as an induced voltage generated in the phase winding 12. More specifically, the voltage detection unit 44 detects a terminal voltage Vu of the terminal 13u as a U-phase voltage of the U-phase winding 12u when the energization is performed between the terminals 13v, 13w of the motor unit 1. The voltage detection unit 44 detects a terminal voltage Vv of the terminal 13v as a V-phase voltage of the V-phase winding 12v when the energization is performed between the terminals 13w, 13u of the motor unit 1, and detects a terminal voltage Vw of the terminal 13w as a W-phase voltage of the W-phase winding 12w when the energization is performed between the terminals 13u, 13v of the motor unit 1.

As described above, the motor drive control device 4 includes the determination unit 45. The determination unit 45 executes various determinations.

As described above, the motor drive control device 4 includes the position information generation unit 46. The position information generation unit 46 generates rotational position information in a rotational direction of the rotor 10 of the motor unit 1 based on a detection result of the voltage detection unit 44.

As described above, the motor drive control device 4 includes the rotation speed detection unit 47. The rotation speed detection unit 47 detects a rotation speed of the rotor 10 of the motor unit 1 based on the rotational position information.

### 1-4. Example of Drive Control of Motor Unit

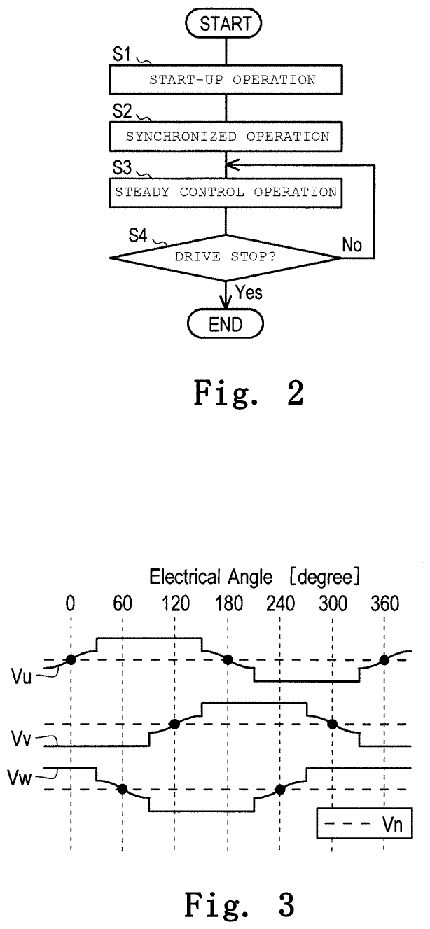

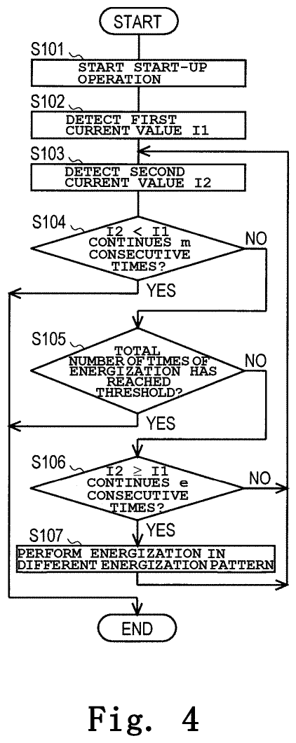

An example of drive control processing of the motor unit 1 by the motor drive control device 4 will be described below. FIG. 2 is a flowchart for describing an example of drive control of the motor unit 1. FIG. 3 is a graph illustrating an example of the terminal voltages Vu, Vv, Vw detected in accordance with an electrical angle of the rotor 10 in the sensorless control of the motor unit 1. In FIG. 3, curved portions of the respective terminal voltages Vu, Vv, Vw indicate the terminal voltages at a non-energizing time.

At the time of start in FIG. 2, the rotor 10 of the motor unit 1 is stopped or rotated at a low speed. Thus, in order to generate the induced voltage necessary for creating the rotational position information in each of the phase windings 12u, 12v, 12w, the drive control unit 41 executes start-up operation of the motor unit 1 (step S1). In the start-up operation, after initial processing such as a short brake is performed, the rotor 10 of the motor unit 1 is forcibly driven to rotate by forced commutation. In the forced commutation, specific two of the three phase windings of the motor unit 1 are energized and excited for each predetermined energization period. A combination of the two phase windings 12 is switched in the predetermined order. In each energization pattern, the remaining one phase winding 12 is not energized. For example, when the energized phases are the U-phase and the V-phase, the non-energized phase is the W-phase.

Subsequently, in order to accelerate the rotation of the rotor 10, the drive control unit 41 executes synchronized operation of the motor unit 1 (step S2). In the synchronized operation, the position information generation unit 46 creates the rotational position information in each energization pattern based on, for example, detection results of timing at which the phase voltage of the non-energized phase becomes equal to a virtual neutral point voltage Vn, and of a tendency in increase and decrease of the phase voltage of the non-energized phase at the timing.

For example, in a case of excitation as shown in FIG. 3, when the virtual neutral point voltage Vn is 3 V, for example, and the U-phase is the non-energized phase, the rotational position of the rotor 10 is detected as 0 degrees (or 360 degrees) in the electrical angle at a point where the terminal voltage increases to 3 V. The rotational position of the rotor 10 is detected as 180 degrees in the electrical angle at a point where the terminal voltage decreases to 3 V.

When the V-phase is the non-energized phase, the rotational position of the rotor 10 is detected as 120 degrees in the electrical angle at a point where the terminal voltage increases to 3 V. At a point where the terminal voltage decreases to 3 V, the rotational position of the rotor 10 is detected as 300 degrees in the electrical angle.

When the W-phase is the non-energized phase, the rotational position of the rotor 10 is detected as 60 degrees in the electrical angle at a point where the terminal voltage decreases to 3 V. At a point where the terminal voltage increases to 3 V, the rotational position of the rotor 10 is detected as 240 degrees in the electrical angle.

In the synchronized operation, the drive control unit 41 accelerates the rotation of the rotor 10 by switching the energization pattern according to the rotational position information for each energization period according to the rotation speed of the rotor 10.

When the rotation speed reaches a predetermined speed or more, the drive control unit 41 executes steady control operation of the motor unit 1 (step S3). In the steady control operation, the rotor 10 is rotated at a desired rotation speed, the energization pattern is switched according to drive information and the rotational position information of the motor unit 1, and the motor unit 1 is driven. Subsequently, when the driving of the motor unit 1 is stopped (YES in step S4), the drive control processing in FIG. 2 ends.

### 1-4-1. Example of Start-Up Operation of Motor Unit

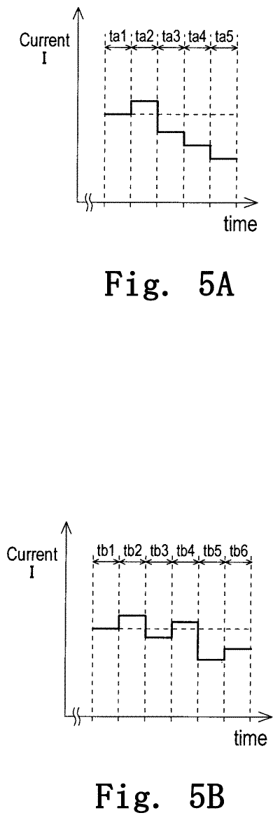

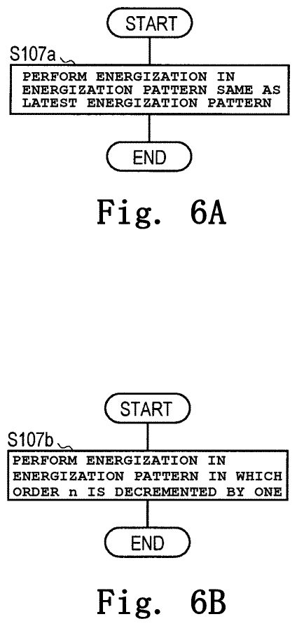

An example of the start-up operation of the motor unit 1 will be specifically described below. FIG. 4 is a flowchart for describing the example of the start-up operation of the motor unit 1. FIG. 5A is a graph illustrating an example of the current value I flowing through the motor unit 1 in each energization period. FIG. 5B is a graph illustrating an example of the current value I flowing through the motor unit 1 in each energization period. In FIG. 5A and FIG. 5B, each of the energization periods ta1, tb1 is an energization period of a first time in which the energization is performed in the energization pattern that switches the phase windings 12u, 12v, 12w in the predetermined order n. Each of the energization periods ta2, ta3, ta4, ta5 in FIG. 5A and the energization periods tb2, tb3, tb4, tb5, tb6 in FIG. 5B is an energization period of a second or subsequent time in which the energization is performed in the energization pattern that switches the phase windings 12u, 12v, 12w in the predetermined order n.

After the initial processing such as the short brake is performed, the drive control unit 41 starts the start-up operation by the forced commutation (step S101). In the short brake, the rotor 10 is stopped by short-circuiting the terminals 13u, 13v, 13w of the motor unit 1.

The energization of the first time is performed to the phase winding 12 in a predetermined energization pattern by the drive control unit 41, and the current detection unit 42 detects a first current value I1 flowing through the motor unit 1 (step S102). At this time, for example, the current value flowing from the terminal 13w to the terminal 13v and flowing from the current detection resistance 3a toward the ground terminal GND is detected as the first current value I1.

Subsequently, the energization of the second or subsequent time is performed to the phase winding 12 in the energization pattern switched in the predetermined order n by the drive control unit 41, and the current detection unit 42 detects a second current value I2 flowing through the motor unit 1 for each time (step S103). At this time, for example, in a case where the energization of the second time is performed, the current value flowing from the terminal 13u to the terminal 13v and flowing from the current detection resistance 3a toward the ground terminal GND is detected as a second current value I2.

The determination unit 45 determines whether or not the second current value I2 is smaller than the first current value I1 for m consecutive times (step S104). It should be noted that m is a positive integer of two or more. When the second current value I2 is smaller than the first current value I1 for m consecutive times (YES in step S104), processing in FIG. 4 ends and the drive control unit 41 starts the synchronized operation of the motor unit 1.

When the second current value I2 is not smaller than the first current value I1 for m consecutive times (NO in step S104), it is determined whether or not the total number of the energizations has reached a threshold (step S105). When the total number of the energizations has reached the threshold (YES in step S105), the processing in FIG. 4 ends and the drive control unit 41 starts the synchronized operation of the motor unit 1.

When the total number of the energizations has not reached the threshold (NO in step S105), the determination unit 45 determines whether or not the second current value I2 is larger than or equal to the first current value I1 for e consecutive times (step S106). It should be noted that e is a positive integer of two or more. When the second current value I2 is not larger than or equal to the first current value I1 for e consecutive times (NO in step S106), in order to perform the energization in the energization pattern switched in the order n and the detection of the second current value I2, a process returns to S103.

When the second current value I2 is larger than or equal to the first current value I1 for e consecutive times (YES in step S106), as described later, the drive control unit 41 performs the energization to the phase winding 12 in an energization pattern different from the energization pattern according to the order n (step S107). Subsequently, in order to detect the second current value I2, the process returns to step S103. When the process returns from step S107 to S103, in step S103, the second current value I2 is detected without the energization in the energization pattern switched in the order n.

As described above, in the start-up operation of the motor unit 1, the drive control unit 41 starts the synchronized operation in which the energization pattern is switched according to the rotational position information when the second current value I2 detected by the current detection unit 42 at energization of a second or subsequent time in the energization pattern is smaller than the first current value I1 detected by the current detection unit 42 at energization of a first time in the energization pattern for m (m is the positive integer of two or more) consecutive times.

In this way, the process can be shifted to the synchronized operation at a timing when the rotor 10 rotates smoothly in the start-up operation. This is because the phase voltage applied to the phase winding 12 is equal to the sum {(R×I)+L×(dϕ/dt)} of the product of impedance R of the phase winding multiplied by the current value I and the induced voltage obtained by the product of inductance L of the phase winding 12 multiplied by the amount of change (dϕ/dt) in magnetic flux per unit time. The current value I flowing through the phase winding 12 is affected by the rotation of the rotor 10. In the energization of the first time in the energization pattern during the start-up operation, the rotor 10 rotates from a stopped state. Thus, influence of the induced voltage acts relatively slightly in a direction of decreasing the current value I flowing through the phase winding 12. When the rotor 10 rotates smoothly and the rotation speed increases, the influence of the induced voltage acts relatively greatly in the direction of decreasing the current value I flowing through the phase winding 12. Unless a smooth rotation is performed due to such as deceleration of the rotor 10, the influence of the induced voltage acts in a direction of increasing the current value I.

In the start-up operation in FIG. 4, using these findings, as shown in FIG. 5A and FIG. 5B, when the second current value I2 of the second or subsequent time in a kth energization pattern is smaller than the first current value I1 of the first time in a first energization pattern for m consecutive times, the process shifts from the start-up operation to the synchronized operation. The synchronized operation drives the motor unit 1 while determining the phase winding 12 to be excited based on the rotational position information (see FIG. 3) of the rotor 10 calculated from the detection result of the voltage detection unit 44.

Thus, a start-up success rate of the motor unit 1 can be increased. Further, since the start-up of the motor unit 1 becomes easy to succeed without a restart also executing the initial processing and the like, start-up time of the motor unit 1 is also reducible.

In step S104, the number of consecutive times m that satisfies I2<I1 is preferably three. As shown in FIG. 5A, the drive control unit 41 preferably starts the synchronized operation when the second current value I2 is smaller than the first current value I1 for three consecutive times. In this way, the start-up success rate of the motor unit 1 can be further increased.

As shown in steps S106 and S107 in FIG. 4, when the second current value I2 is larger than or equal to the first current value I1 for e (e is the positive integer of two or more) consecutive times, the drive control unit 41 continues the start-up operation after changing the next energization pattern to the energization pattern different from the energization pattern according to the order n. That is, when the second current value I2 is larger than or equal to the first current value I1, it is determined that the rotor 10 is not rotating smoothly. By energizing the phase winding 12 in the energization pattern different from the energization pattern according to the predetermined order n and continuing the start-up operation, an irregular change is applied to the rotation of the rotor 10. In this way, an attempt can be made to improve the start-up success rate of the motor unit 1.

In step S106, the number of consecutive times e that satisfies I2≥I1 is preferably two. In other words, when the second current value I2 is larger than or equal to the first current value I1 for two consecutive times, the drive control unit 41 continues the start-up operation after changing the next energization pattern to the different energization pattern described above. In this way, an attempt can be made more efficiently to improve the start-up success rate of the motor unit 1.

In the start-up operation in FIG. 4, a first energization period of the first time is preferably longer than a kth (k is a positive integer of two or more) energization period of the second or subsequent time. The period in which the energization of the first time is performed in the first energization pattern is preferably longer than each period in which the energization of the second or subsequent time is performed in the kth energization pattern. When the energization of the first time is started, the rotor 10 is stopped or rotated at the low speed. Thus, a relatively large driving force is required for the rotor 10. By sufficiently lengthening the first energization period for starting the forced commutation, a sufficient driving force is applied to the rotor 10, so that the rotor is easily rotated.

In the start-up operation in FIG. 4, each energization period is preferably and gradually shortened. For example, in the period in which the energization of the second or subsequent time is performed, the period in which each energization is performed is preferably shortened as the number of times of energization increases. Alternatively, in each of the periods in which the energization of the first or subsequent time is performed in the energization pattern, the period in which each energization is performed is preferably shortened as the number of times of energization increases. In this way, each energization period in which the energization pattern is switched in the predetermined order is gradually shortened, so that the start-up operation shifts to the synchronized operation in a shorter time. The present disclosure is not limited to these exemplifications, and each of the energization periods may have the same length of time.

### 1-4-2. Processing of Energizing in Different Energization Patterns

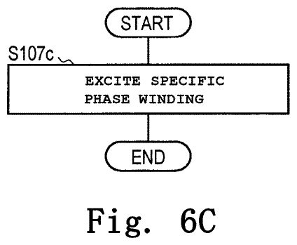

Examples of step S107 in FIG. 4 will be described below with reference to FIG. 6A to FIG. 6C.

### 1-4-2-1. First Example

FIG. 6A is a flowchart for describing a first example of the processing of energizing in the different energization pattern. In the first example, in the processing of energizing in the different energization pattern of step S107 in FIG. 4, the phase winding 12 is energized in the same energization pattern as the latest energization pattern (step S107a). Subsequently, the process returns to step S103 in FIG. 4.

The energization pattern different from the energization pattern according to the order n performed in the first example embodiment is the latest energization pattern. In this way, the energization period in the latest energization pattern when the second current value I2 is larger than or equal to the first current value I1, that is, the latest energization period can be extended. In other words, the energization in the energization pattern according to the order n is extended. When the energization is performed in the nth energization pattern in the previous time, the energization is performed again in the same nth energization pattern as in the previous time. Thus, by extending the energization period in the same energization pattern instead of changing the energization pattern, it is attempted whether or not the rotor 10 is more quickly and smoothly rotatable.

### 1-4-2-2. Second Example

FIG. 6B is a flowchart for describing a second example of the processing of energizing in the different energization pattern. In the second example, in the processing of energizing in the different energization pattern of step S107 in FIG. 4, the phase winding 12 is energized in the energization pattern in which the order n is decremented by one from the latest energization pattern (step S107b). Subsequently, the process returns to step S103 in FIG. 4.

The energization pattern different from the energization pattern according to the order n performed in the second example is the energization pattern in which the order n is decremented by one from the latest energization pattern. In this way, the order of energization pattern is decremented by one, and the start-up operation is continued. In other words, the energization is performed in the energization pattern according to the order (n−1). That is, when the energization is performed in the nth energization pattern in the previous time, the energization is performed in the (n−1)th energization pattern. Thus, it is attempted whether the rotational position of the rotor 10 becomes a position where the rotor more smoothly rotates.

### 1-4-2-3. Third Example

FIG. 6C is a flowchart for describing the third example of the processing of energizing in the different energization pattern. In the third example, in the processing of energizing in the different energization pattern of step S107 in FIG. 4, the drive control unit 41 excites the specific phase winding 12 by energization in the energization pattern different from the energization pattern according to the order n in the kth energization period (step S107c). Subsequently, the process returns to step S103 in FIG. 4.

The drive control unit 41 excites the specific phase winding 12 for a predetermined time in the energization pattern different from the energization pattern according to the order n performed in the third example. In this way, for example, by energizing the two phase windings 12, after a large change is applied to the rotation of the rotor 10, the start-up operation is continued. Thus, it is attempted whether the rotational position of the rotor 10 becomes a position where the rotor more smoothly rotates.

### 2. Others

As described above, in the present disclosure, the example embodiment has been described. The scope of the present disclosure is not limited to the present disclosure. The present disclosure can be implemented with various modifications without departing from the spirit and scope of the disclosure. The matters described in the present disclosure may be appropriately and arbitrarily combined as long as there is no inconsistency.

The present disclosure is useful for the motor drive control device, the motor, and the blower apparatus that perform the sensorless control of the motor unit.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor drive control device comprising:
a drive control unit that controls driving of a motor unit to which a three-phase alternating current voltage is inputted and that switches an energization pattern to phase windings of the motor unit in a predetermined order;
a current detection unit that detects a current value flowing through the motor unit;
a storage unit that stores the current value detected by the current detection unit for each energization in the energization pattern;
a voltage detection unit that detects a voltage of each of the phase windings; and
a position information generation unit that generates rotational position information of a rotor of the motor unit in a rotational direction based on a detection result of the voltage detection unit,
wherein in start-up operation of the motor unit, the drive control unit starts synchronized operation for switching the energization pattern according to the rotational position information when a second current value detected by the current detection unit at energization of a second or subsequent time in the energization pattern is smaller than a first current value detected by the current detection unit at energization of a first time in the energization pattern for m consecutive times, where m is a positive integer of two or more.

2. The motor drive control device according to claim 1, wherein the drive control unit starts the synchronized operation when the second current value is smaller than the first current value for three consecutive times.

3. The motor drive control device according to claim 1, wherein the drive control unit continues the start-up operation after changing the next energization pattern to a different energization pattern different from the energization pattern according to the order when the second current value is larger than or equal to the first current value for e consecutive times, where e is a positive integer of two or more.

4. The motor drive control device according to claim 3, wherein the drive control unit continues the start-up operation after changing the next energization pattern to the different energization pattern when the second current value is larger than or equal to the first current value for two consecutive times.

5. The motor drive control device according to claim 3, wherein the different energization pattern is the latest energization pattern.

6. The motor drive control device according to claim 3, wherein the different energization pattern is the energization pattern in which the order is decremented by one from the latest energization pattern.

7. The motor drive control device according to claim 3, wherein the drive control unit excites the specific phase winding for a predetermined time in the different energization pattern.

8. The motor drive control device according to claim 2, wherein the drive control unit continues the start-up operation after changing the next energization pattern to a different energization pattern different from the energization pattern according to the order when the second current value is larger than or equal to the first current value for e consecutive times, where e is a positive integer of two or more.

9. The motor drive control device according to claim 8, wherein the drive control unit continues the start-up operation after changing the next energization pattern to the different energization pattern when the second current value is larger than or equal to the first current value for two consecutive times.

10. The motor drive control device according to claim 8, wherein the different energization pattern is the latest energization pattern.

11. The motor drive control device according to claim 8, wherein the different energization pattern is the energization pattern in which the order is decremented by one from the latest energization pattern.

12. The motor drive control device according to claim 8, wherein the drive control unit excites the specific phase winding for a predetermined time in the different energization pattern.

13. The motor drive control device according to claim 1, wherein a period for performing the energization of the first time in the energization pattern is longer than each period for performing the energization of the second or subsequent time in the energization pattern.

14. The motor drive control device according to claim 13, wherein in the period for performing the energization of the second or subsequent time, the period for performing each energization is shortened as the number of times of energization increases.

15. The motor drive control device according to claim 13, wherein in each period for performing the energization of the first or subsequent time in the energization pattern, the period for performing each energization is shortened as the number of the energizations increases.

16. A motor comprising:
a motor unit to which a three-phase alternating current voltage is inputted; and
a motor drive control device according to claim 1 for controlling driving of the motor unit.

17. A blower apparatus comprising:
an impeller including blades rotatable around a central axis extending in a vertical direction; and
the motor according to claim 16 for rotating the blades.
